(19) United States
(12) Patent Application Publication
(10) Pub. No.: US 2006/0153252 A1
(43) Pub. Date: Jul. 13, 2006

(54) Optical reading apparatus and method of reading data

(76) Inventors: Ole Klembt Andersen, VOORBURG (NL); Coen Theodorus Hubertus Fransiscus Liedenbaum, Eindhoven (NL); Robert Frans Maria Hendriks, Eindhoven (NL); Gert Wim T Hooft, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/543,431

(22) PCT Filed: Jan. 21, 2004
(86) PCT No.: PCT/IB04/00186

§ 371 Date: Jul. 26, 2005

(30) Foreign Application Priority Data
Jan. 29, 2003 (EP) 03290226.4

(51) Int. Cl. H01S 3/10

(52) U.S. Cl. 372/21

(57) ABSTRACT

This apparatus having an optical head (15—FIG. 1)) for reading data stored in an optical carrier (1) comprises: a light source constituted by a first laser (50) or master laser for illuminating said carrier, an optical mounting (58) for directing the reflected light from said carrier to a detection branch (65) in which a non-linear optical element (80) is placed. This non-linear optical element (80) improves the signal to noise ratio by its non-linear characteristic before detection by the usual detector (75). The invention can be used for DVD players and/or recorders.

The present invention relates to an apparatus, or a drive, having an optical head for reading data stored in an optical carrier, comprising:

a light source for illuminating said carrier,

an optical mounting for directing the reflected light from said carrier to a detection branch.

This apparatus finds many applications, notably for data carriers constituted by optical discs. Often the data stored in the disc provide output signals which are poor in quality and need processing for improving their readability.

The invention proposes an above-mentioned apparatus in which measures are taken to improve the output quality of the output signal.

According to the invention, such an apparatus having an optical head for reading data stored in an optical carrier comprises:

a light source or master source for illuminating said carrier,

an optical mounting for directing the reflected light from said carrier to a detection branch in which a non-linear optical element is placed, the type of this non-linear element being chosen for improving the signal to noise ratio of the detected information.

The invention also proposes a method of reading an optical data carrier, comprising the steps of:

injecting into a slave laser the light coming from a master light source after reflection at a data carrier,

providing detection means for detecting the light coming from the data carrier by using a non-linear optical element providing an improvement of the signal to noise ratio of the detected information.

The idea of the invention is to use optical means for obtaining a better signal. The non-linear optical devices that the invention recommends are disclosed in the patent documents GB 2 118 765 and U.S. Pat. No. 4,748,630. The measures provided by the invention improve the signal-to noise ratio without using usual electronic circuits.

These and other aspects of the invention are apparent from and will be elucidated, by way of non-limitative example, with reference to the embodiment(s) described hereinafter.

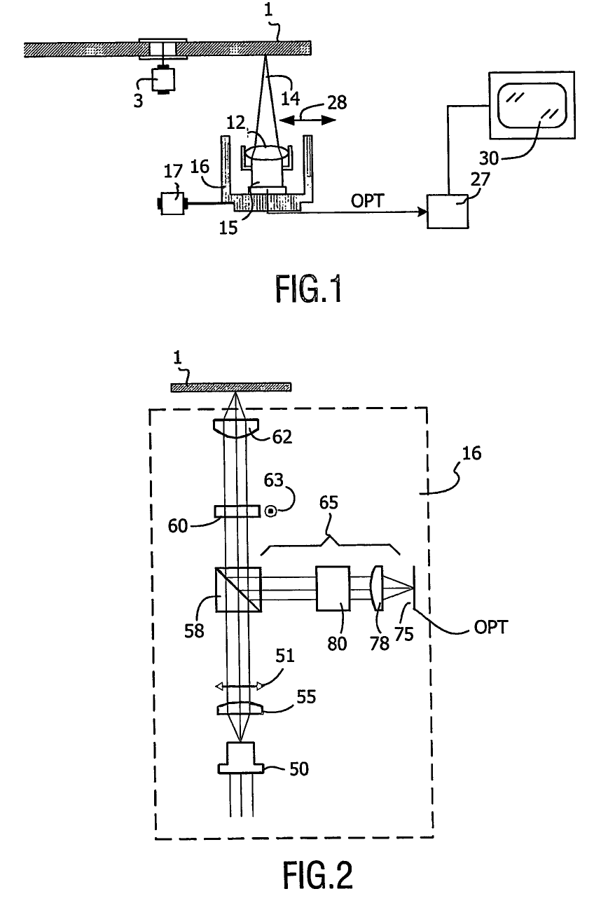

FIG. 1 shows an apparatus in accordance with the invention.

FIG. 2 shows an optical head comprised in said apparatus according to the invention.

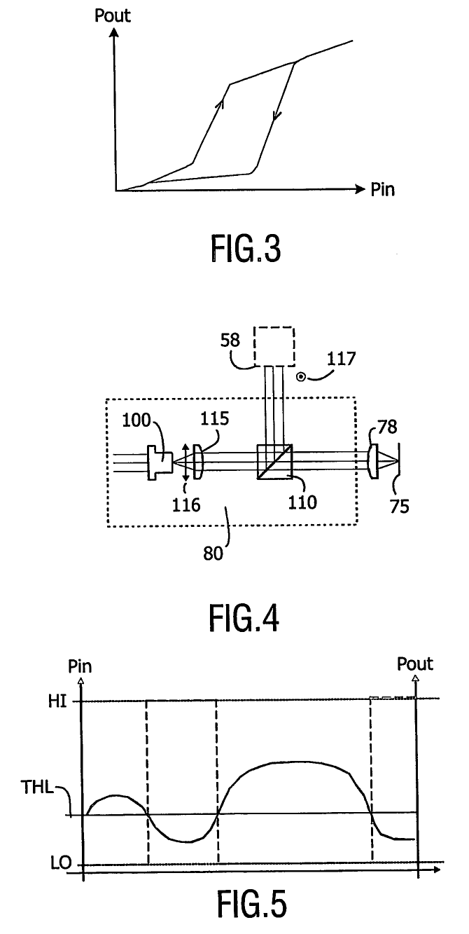

FIG. 3 is a curve, which explains the working of the invention.

FIG. 4 shows a second embodiment of an optical head according to the invention.

FIG. 5 shows the response function of said second embodiment.

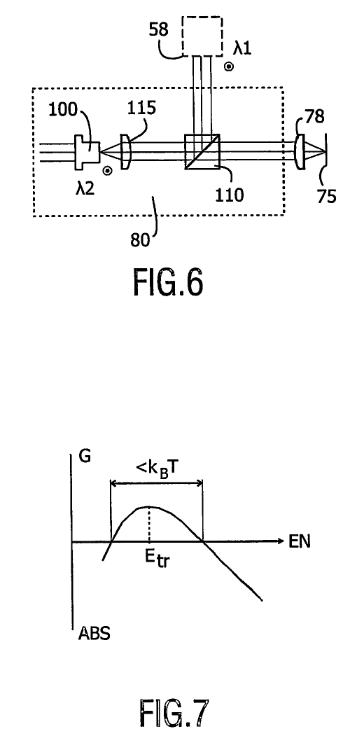

FIG. 6 shows a third embodiment of an optical head according to the invention.

FIG. 7 shows a diagram for explanation of the invention.

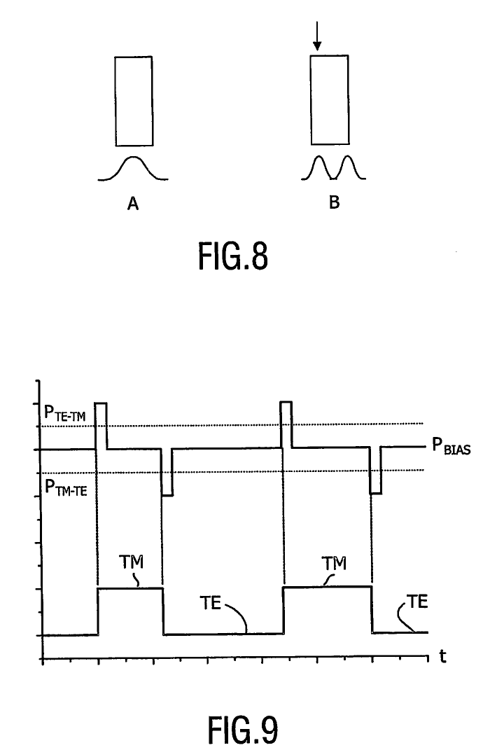

FIG. 8 shows ways for injecting power into laser slave.

FIG. 9 shows a modulation waveform for the third embodiment.

FIG. 1 shows an apparatus in which a data carrier 1, notably an optical disc, is placed. The data carrier is shown in cross section. A lens 12 focuses a light beam 14 onto this carrier, which is driven into a circular movement by a motor 3. The light source is mounted in an Optical head (OPU) 15, which is placed in a slave laser edge 16. This slave laser edge enables large displacements by using a motor 17. These displacements are performed in directions indicated by arrows 28. The signal OPT at the output of the unit 16 is applied to a signal distributor 27, which provides signals for a display unit 30 so that the contents of the disc can be displayed with some other information pertaining to the use of the apparatus.

FIG. 2 shows the optical head 16 realized according to the invention. The head comprises a light source constituted, in this example, by a diode laser 50, which provides a linear polarized light, the direction of polarization being indicated by the usual symbol 51. The beam of light from the diode laser 50 is collimated by the collimating lens 55 and transmitted through a polarizing cubic beam-splitter 58. After being passed through a quarter-wave plate (λ/4-plate) 60, the light is focused onto the information layer of the optical disc 1 by the objective lens 62. The light reflected from the disc is passed through the (λ/4-plate) 60 with the polarization indicated by the symbol 63 and reflected toward the detection branch 65 by the splitter 58. In the detection branch 65, the light reflected from the disc is focused onto a detector 75 by a collimating lens 78.

According to an aspect of the invention, a non-linear optical element 80 is provided in the detection branch A non-linear optical element can be defined by a typical response curve, giving the output power of the element as a function of the input power. An example is given in FIG. 3. Other examples of non-linear curves suitable for the invention will be given later in this disclosure.

The typical output intensity Pout as a function of the input intensity Pin is shown in this FIG. 3. This curve shows a type of non-linearity required by the measure of the invention. In this Fig. a hysteresis phenomenon can be observed. However, hysteresis is not always a prerequisite.

A first embodiment shown in FIG. 4 provides amplification of the light. The non-linear optical element 80 comprises a second laser diode 100 having a high output power as compared with amount of light injected into said laser diode 100. This laser 100 is considered a slave laser whereas the laser 50 is considered a laser master. This slave laser 100 receives light from the disc 1 via a polarizing beam splitter 110. This light is focused by a lens 115 on the laser 100 in a way calculated to disturb its operatyion. The light of the laser 100 is directed to the detector 75 via the lens 78. This second embodiment is based on the change of the light polarization of the laser 100 as a function of the light received from the master laser 50. The polarization direction of the slave laser 100 is perpendicular (symbol 116) to the polarization direction of the light injected (symbol 117) into the slave laser 100. If however, the amount of reflected light exceeds a certain threshold value, the polarization direction of the slave laser 100 is changed and becomes aligned with the polarization direction of the injected light. Hence, for low levels of injected light, the light emitted by the slave laser 100 is transmitted through the polarizing beam splitter 110. If the amount of injected light exceeds the threshold value, the polarization of the slave laser 100 changes and is reflected by the PBS 58. The output from the element 80 is therefore either ‘high’ or ‘low’, depending on whether the amount of injected light is below or above the threshold level THL, respectively.

FIG. 5 gives the output characteristics of this element 80 shown in FIG. 4. The curve in dashed line is the output power Pout provided by the slave laser 100 and Pin is the input power that the laser receives from the master after reflection at the optical disc. It can be seen that the output power is therefore either “high” or “low”. These levels of output power are referenced HI and LO, respectively, in FIG. 5. When the input level is above the threshold value THL or below it, the level is therefore HI or LO, respectively. The input power or injection power is of the order of 1 mW, and the switching time between “high” and “low” is a few hundred pico-seconds.

Another method is to use the threshold condition of the laser 100. For small amounts of light reflected from the disc, the slave laser will operate below its lasing threshold and a negligible amount of light is emitted. As the amount of reflected light increases the slave laser is forced to operate above the threshold, with the consequence that the output power increases substantially. The emitted optical power is very low when the electric current is below the threshold value. The output-power ratio between the HI level and the LO level is determined by the total number of modes in which spontaneous emission is generated. The typical value of this ratio is 10⁶-10⁷. This embodiment is shown in FIG. 6. Like entities in this Fig. are designated by the same letter references as in previous Figures. The slave laser without injection of light reflected from the disc is kept just below threshold. The wavelength of the free-running slave laser is λ2. The light emitted by the master laser in FIG. 1 (and hence injected into the slave laser after reflection from the disc) has the wavelength λ1. It is possible to distinguish between two situations:

(a) the wavelength λ1 of the light injected into the slave laser is very close to the wavelength λ2 of the (free-running) slave laser, i.e. λ1≈λ2, and

(b) the wavelength of the light injected into the slave laser is much shorter than the emission wavelength of the slave laser, i.e. λ1<<λ2.

To understand the difference, the gain G and the absorption ABS of a semiconductor laser operating above threshold is considered as a function of energy EN, see FIG. 7. The dependence is characterized by a region of positive gain whose maximum determines the position of the lasing wavelength (denoted Eₜᵣ in FIG. 7). It is assumed that the slave laser is operating in the near infrared with Eₜᵣ=1.57 eV (−790 nm). The width of the slave laser gain region is approximately 25 meV, which, at this wavelength, corresponds to approximately 15 nm.

For the case where λ1≈λ2, the injected wavelength, λ1, falls within the positive-gain region of the slave laser. Here the master laser and the slave laser are of the same type with nearly the same emission wavelengths. In this situation, injection of light corresponds to a reduction of the optical losses of the laser cavity, assuming that the slave laser, in free-running mode, is operating just below threshold. The result of the injected light is to force the laser above the threshold at the injected wavelength. If λ1<<λ2, the light injected into the slave laser is absorbed and transformed into electron-hole pairs. The effect of the extra generated electron-hole pairs is similar to an increased injection current level. Hence, in this way the laser can also be forced to operate above threshold.

Yet another implementation is to use transverse mode switching induced by injection of light reflected from the information carrier. Without (or with only a small amount of) injected light, the slave laser operates in the free-running transverse mode, see FIG. 8A. With injection, another transverse mode has lower losses than the free-running mode and it is therefore the new lasing mode, see FIG. 8B. Due the non-linear aspects of the mode competition, this will lead to a mode switch. A detector can be placed in a node of one of the modes, which is an anti-node of the other mode (in FIGS. 8A and 8B, the detector should therefore be placed on the optical axis). Transverse mode switching can be used with lasers of the type VCSEL (Vertical-Cavity Surface-Emitting Laser) and edge emitters.

Instead of using an edge-emitter semiconductor laser, it is also possible to use a VCSEL in the detection branch. In this situation the master laser shown in FIG. 2 is a conventional edge-emitting laser, whereas the slave laser indicated in FIG. 4 and FIG. 6 is a VCSEL. Since the polarization direction of the light emitted by a VCSEL can be changed by changing the bias current, VCSELs are well suited for a non-linear element 80 based on polarization switching. The mirror reflectivity of a VCSEL is much higher than the corresponding reflectivity of an edge emitter. This makes it difficult to inject light into the VCSEL if the wavelength of the injected light is close to the emission wavelength of the VCSEL. Hence, when using a VCSEL in the non-linear element 80, it is advantageous to keep the wavelength of the VCSEL much longer than the wavelength of the injected light.

In a practical situation the slave laser is pulsed through current modulation. Just below threshold the slave laser is very sensitive to injection from the master laser.

For the situation where the non-linear optical element exhibits hysteresis, the response function shown in FIG. 5 is replaced by the response function shown in FIG. 9. It is assumed that the reflected light from the disc has a time dependence as shown in the upper curve of FIG. 9. Whenever the injection level exceeds P_{TE-TM}, the slave laser changes its state from TE to TM: lower curve of FIG. 9. When the level of reflected light drops below P_{TM-TE} the state of the slave laser returns to TE. The reflected light does in fact not need to have the narrow pulsed character, as indicated in the upper curve of FIG. 9. The condition that should be fulfilled is that the amount of injected light either exceeds P_{TE-TM} or drops below P_{TM-TE}.

If the bias level is chosen close to threshold so that slave laser has laser action in the TM state, but does not lase when it is in the TE state, the integrated monitoring photodiode (MPD) may be used for bit detection. The MPD has a large bandwidth (several GHz) and is well suited for detecting whether the laser is lasing or not.

Advantages

The typical optical read-out power on the disc in an optical disc drive is approximately 0.5 mW. Increasing the read-out power above this value would erase information written on RW media. Realistic reflection coefficients for +RW discs are 0.15 (unwritten), and 0 (written) giving an average reflection coefficient of 0.075. This means that the typical currents induced in the detector (assuming a conversion gain of 0.2 A/W) are:
i=0.5 mW×0.075×0.2 A/W≈8 μA
The contribution from the detector noise to the total noise is given by:

$$\frac{Δ V}{V} = \frac{1}{〈 i 〉} \sqrt{2 {k}_{B} Tf ω C}$$

where <i> is the average current on the detector, ωC the capacitive resistance of the detector, k_{B}T the energy equivalent to the temperature T, and f the frequency bandwidth of the detector. For high-speed applications it is necessary to increase the frequency bandwidth of the detector, which means that the contribution from the detector noise increases correspondingly.
In BLU-RAY (BD) players, the dominant noise sources are laser noise (RIN) and detector noise (as given by the expression for ΔV/V).
The RIN increases linearly with the frequency f. The RIN should, however, be compared with the detector-noise power, (ΔV/V)², which increases with f². For 1× BD the RIN is the dominant noise term. The detector noise becomes dominant at higher speeds.
As was mentioned above, the non-linear optical element placed in the detection branch incorporates its own laser (either an edge emitter or a VCSEL). It assumed that, when the output from the NOE is high, the emitted optical power is ˜0.5 mW. This light falls on the detector and induces the current:
i=0.5 mW×0.2 A/W≈100 μA
Compared with the situation without a non-linear optical element (NOE) the current gain is 100/8˜12.5 which corresponds to 22 dB. For this case the introduction of the NOE reduces the detector noise contribution by 22 dB. This would then allow for an increased frequency bandwidth.

The presented idea hence offers a possibility to decrease the contribution from detector noise (which is the dominant noise term for high-speed applications) in, for example, BD players.

Another advantage of using a non-linear optical element for readout is the reduced sensitivity to media noise. As was described above, bits are detected when the reflected light from the disc crosses a threshold value. This means that reflectivity variations inherent in the disc-material do not play an important role as long as the variations are not so large that the threshold value is crossed.

Furthermore, since the detection of bits is reduced to a detection of transitions between two states (HI and LOW)n, this means that the slicer implemented in the current disc drives would be redundant. The purpose of the slicer is to detect the DC level around which the reflected light from the disc is modulated (this DC level is not necessarily constant but may show fluctuations). However, the DC level is constant for the non-linear optical element, see FIG. 5.

The dynamic range, i.e. the reflectivity difference between marks and empty space, depends on the type of disc, for example, +RW discs have a different dynamic range from ROM discs. Again, since the detection of information is reduced to a threshold transition, readout with a non-linear optical element offers an increased compatibility robustness.

In contrast to low-power diode lasers, high-power diode lasers operating around 405 nm are known to be noisy. Laser noise is very likely to be reduced as a consequence of the injection of less noisy light from the low-power diode laser.

Some references are cited for illustrating this disclosure.
[1] A. Sapia, P. Spano, and B. Daino, “Polarization switching in semiconductor lasers driven via injection from an external radiation”, Appl. Phys. Lett. 50, 57-59, 1987.
[2] Y. Mori, J. Shibata, and T. Kajiwara, “High switching-speed optical RS flip-flop constructed of a TM-wave injected semiconductor laser”, Int. Electron Devices Meeting Technical Digest, 610-613, Los Angeles, 1986.
[3] Z. G. Pan et al., “Optical injection induced polarization bistability in vertical-cavity surface emitting lasers”, Appl. Phys. Lett. 63, 2999-3001, 1993.
[4] G. Knowles, S. J. Sweeney, T. E. Sale, and A. R. Adams, “Self-heating effects in red (665 nm) VCSELs”,
   IEEE Proc. Optoelectron. 5/6, 256-260, 2001.

1- An apparatus having an optical head for reading data stored in an optical carrier, comprising:
a light source or master source for illuminating said carrier,
an optical mounting for directing the reflected light from said carrier to a detection branch in which a non-linear optical element is placed, the type of this non-linear element being chosen for improving the signal to noise ratio of the detected information.

2- An apparatus as claimed in claim 1, wherein said master source is a laser.

3- An apparatus as claimed in claim 1 or 2, wherein said non-linear optical element is constituted by a second laser or slave laser into which the reflected light is injected so as to emit light to a light detector for providing said detected information, said emitted light having a magnitude related to the reflected light in a non-linear, monotonic fashion.

4- An apparatus as claimed in claims 1 or 2 or 3, in wherein the second light beam of said non-linear element has a wavelength different from the wavelength of said first light beam.

5- An apparatus as claimed in any of the preceding claims, wherein the second laser is a high-power laser as compared with the first laser.

6- An apparatus as claimed in any of the preceding claims, wherein the second laser changes its polarization in accordance with the polarization of the light which is injected into it.

7- An apparatus as claimed in any of the preceding claims, wherein the second laser changes its transverse mode depending on the amount of light injected from the light source.

8- A method of reading an optical data carrier, comprising the steps of:
injecting into a slave laser the light coming from a master light source after reflection at a data carrier,
providing detection means for detecting the light coming from the data carrier by using a non-linear optical element providing an improvement of the signal to noise ratio of the detected information.

9- An optical disc drive suitable for an apparatus as claimed in claims 1-7.
